(19) United States
(12) Patent Application Publication
(10) Pub. No.: US 2021/0374183 A1
(43) Pub. Date: Dec. 2, 2021

(54) Method and Apparatus for Autonomously Assimilating Content Using a Machine Learning Algorithm

(71) Applicant: Soffos, Inc., Austin, TX (US)

(72) Inventors: Nick Kairinos, Limassol (CY); Petros Mina, Nicosia (CY)

(73) Assignee: Soffos, Inc., Austin, TX (US)

(21) Appl. No.: 17/318,352

(22) Filed: May 12, 2021

Related U.S. Application Data
(60) Provisional application No. 63/033,458, filed on Jun. 2, 2020.

(51) Int. Cl. G06F 16/9035; G06N 20/00; G06F 16/903; G06F 16/9038

(52) U.S. Cl. CPC G06F 16/9035; G06F 16/9038; G06F 16/90335; G06N 20/00

(57) ABSTRACT

A method for using a computer implemented machine learning algorithm (“MLA”) to autonomously assimilate a selected content comprising one or more assertions stored in a persistent memory. The MLA is first trained to infer from each stored assertion a difficulty metric. This metric is then associated with the respective assertion in the memory.

### BACKGROUND

### Field

The present disclosure relates to a method and apparatus for autonomously assimilating content using a machine learning algorithm.

### Description of the Related Art

In general, in the descriptions that follow, we will italicize the first occurrence of each special term of art that should be familiar to those skilled in the art of computer implemented algorithms. In addition, when we first introduce a term that we believe to be new or that we will use in a context that we believe to be new, we will bold the term and provide the definition that we intend to apply to that term.

Hereinafter, when we refer to a facility we mean a circuit or an associated set of circuits adapted to perform a particular function regardless of the physical layout of an embodiment thereof. Thus, the electronic elements comprising a given facility may be instantiated in the form of a hard macro adapted to be placed as a physically contiguous module, or in the form of a soft macro the elements of which may be distributed in any appropriate way that meets speed path requirements. In general, electronic systems comprise many different types of facilities, each adapted to perform specific functions in accordance with the intended capabilities of each system. Depending on the intended system application, the several facilities comprising the hardware platform may be integrated onto a single IC, or distributed across multiple ICs. Depending on cost and other known considerations, the electronic components, including the facility-instantiating IC(s), may be embodied in one or more single- or multi-chip packages. However, unless we expressly state to the contrary, we consider the form of instantiation of any facility that practices our disclosed embodiments as being purely a matter of design choice.

Shown in FIG. 1 is a typical mobile communication system 10. In one embodiment, the system 10 comprises a mobile device 12 and a server facility 14 connected via an interconnection network 16. In the illustrated embodiment, the mobile device 12 is connected to the network 16 via a wireless communication channel 18, and the server facility 14 is connected to the network 16 via a wired communication channel 20. In general, the operation of the mobile communication system 10 is well known in the art.

In a typical embodiment, the mobile device 12 comprises a central processing unit (“CPU”) 22 and a memory facility 24 adapted to store, inter alia: an operating system (“OS”) 26; at least one application program (“App”) 28; and data 30 relating to the operation of the OS 26 and the App 28. An input/output facility 32, comprising a combination display screen and touch panel, facilitates real-time interaction with a user of the mobile device 12. A communication facility (“Comm”) 34, internally coupled to the CPU 22, is adapted to communicate wirelessly via the wireless channel 18 using any of the known wireless communication protocols. In general, the OS 26 can be any of the known mobile operating systems, e.g., the iOS system developed by Apple Inc., or the Android system developed by Google Inc.; or, in some embodiments, any of the known general purpose operating systems, e.g., Windows developed by Microsoft Corporation, Mac OSXdeveloped by Apple Inc., or the UNIX operating system developed by AT&T Inc., including any of the several so-called xNIX variants of the open source Linux.

In most embodiments, the mobile device 12 includes at least one sensor 36, such as a solid-state camera, but may also include one or more microphones (not shown). In some embodiments, the mobile device 12 includes one or more sensors 36 adapted to sense, in real time, ambient environmental conditions, e.g., temperature, humidity, atmospheric pressure, geo-location, and the like. Further, as is known, the camera is well adapted to facilitate measurement of ambient light intensity, and the microphone is well adapted to facilitate measurement of ambient sound intensity. In such embodiments, the OS 26 facilitates communication by the App 28 with the several available sensors 36.

Shown in FIG. 2 is a typical server 14. In general, the several functional facilities comprising server 14 are well known in the art. Typical embodiments of server 14 can be obtained commercially from various suppliers, e.g., Hewlett-Packard Development Company, L.P., Dell, Inc., Apple, Inc., and the like.

Over the years, various attempts have been made to create a machine learning algorithm (“MLA”). However, most of these approaches have met with only limited success, usually as a result of the related projects being of only limited scope. One of the more successful projects of which we are aware was the Knowledge Graph, developed byGoogle LLC to enhance the performance of its search engine. See, Singhal, Amit, “Introducing the Knowledge Graph: Things, Not Strings”, Google Official Blog, 16 May 2012. An even more ambitious project, also by Google LLC, was the Knowledge Vault. See, Dong, Zin Luna, et al., “Knowledge Vault: A Web-Scale Approach to Probabilistic Knowledge Fusion”, KDD′14, 24-27 Aug. 2014, New York, N.Y., USA. We believe that Google LLC is still developing this technology, but are not presently aware of its current state of functionality.

In some graph databases, each knowledge assertion comprises a single Resource Description Framework (“RDF”) semantic triple, (s,p,o), wherein s is the subject of the assertion, p is the predicate, and o is the object. By way of example, we have illustrated in FIG. 3 a single assertion, T₁, wherein S₁ and O₁ are represented as respective nodes, and P₁ is represented as an edge connecting the nodes labeled S₁ and O₁. In many embodiments, the nodes of the graph are allowed to have one or more attributes associated therewith. In FIG. 3, we have illustrated this feature, wherein a first attribute, A₁, is associated with S₁, and a second attribute, A₂, is associated with O₁. In the aggregate, the set of assertions represent a knowledge base that is computer readable.

In FIG. 4, we have illustrated one way to associate with the assertion T₁ of FIG. 3 a selected metric using a first Tag, M₁. For example, in the Knowledge Vault, the MLA is tasked with assessing the correctness or truthfulness of each assertion. It does so using a selected set of heuristics, each of which approaches this question from a different perspective, but which, in the aggregate, tends to converge to a reasonable quantitative assessment of veracity. Having inferred this metric, Google's MLA associates the metric with the respective assertion using a respective tag.

With respect to all of the prior art systems of which we are aware, we have found none that attempt to infer, during the process of initially assimilating content, the relative difficulty an “average” user might experience in learning particular assertions derived from that content. Further, we are not aware of any such system that thereafter uses an MLA to further refine such a difficulty metric to better fit each particular user.

Therefore, in light of the foregoing, we submit that there exists a need to address, for example to overcome, the problem of presenting content to a user that is not appropriate to that users intellectual abilities. Further, we submit that what is needed is a content discrimination method that is at least as efficient, but more effective than, the known art.

### BRIEF SUMMARY

In accordance with our disclosed embodiments, we provide a method for autonomously assimilating Content comprising an Assertion, using a Machine Learning Algorithm (“MLA”), characterized in that the method comprises configuring an electronic data processing facility to perform the steps of: adapting the MLA to Infer from the Assertiona Difficulty Metric; and associating the Difficulty Metric with the Assertion.

In accordance with yet another embodiment of the present disclosure, a computer system may be configured to practice our Content assimilation methods.

In accordance with still another embodiment of the present disclosure, a non-transitory computer readable medium may include executable instructions which, when executed in a processing system, causes the processing system to perform the steps of our Content assimilation methods.

### BRIEF DESCRIPTION OF THE SEVERAL VIEWS OF THE DRAWINGS

Our disclosed embodiments may be more fully understood by a description of certain preferred embodiments in conjunction with the attached drawings in which:

FIG. 1 illustrates, in block diagram form, a mobile communication system adapted to practice our invention;

FIG. 2 illustrates, in block diagram form, a typical server facility adapted to practice our disclosed embodiments;

FIG. 3 illustrates, in graph form, a prior art single RDF triple;

FIG. 4 illustrates, in graph form, the RDF triple of FIG. 3 with a pair of associated Tags;

FIG. 5 illustrates, in block diagram form, several functional facilities comprising a generic embodiment of our content assimilation system;

FIG. 6, comprising FIG. 6A, FIG. 6B, and FIG. 6C, illustrates, in graph database form, one embodiment of the tagged RDF triple of FIG. 4;

FIG. 7, comprising FIG. 7A, FIG. 7B, and FIG. 7C, illustrates, in graph database form, one embodiment of an indexing mechanism for expediting searching of the database;

FIG. 8 is a flow diagrams illustrating a method of autonomous assimilation of a content using a machine learning algorithm in accordance with an embodiment of the present invention.

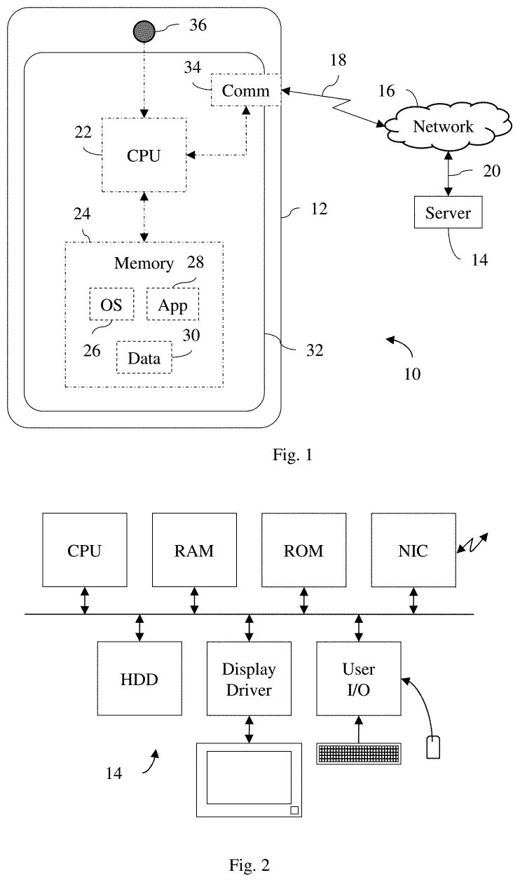

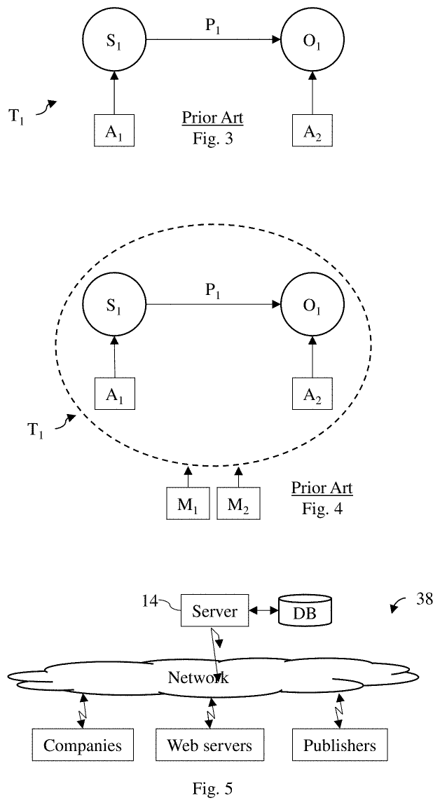

In the drawings, similar elements will be similarly numbered whenever possible. However, this practice is simply for convenience of reference and to avoid unnecessary proliferation of numbers, and is not intended to imply or suggest that our disclosed embodiments requires identity in either function or structure in the several embodiments.

### DETAILED DESCRIPTION OF THE EMBODIMENTS

For convenience of reference, we shall hereafter use the following capitalized terms:
Algorithm means a process flow implemented in the form of computer executable instructions generated using a selected one or more of the currently available programming languages;
Cognitive Skill means an Inference of the skill required of a User to comprehend a selected content;
Content means information comprising assertions relating to a selected one or more
   topics;
Difficulty Metric means an Inferred number indicative of the difficulty a User would experience in learning an Assertion, e.g., a Cognitive Skill or a Learning Capacity;
Inference means a prediction made by a MLA as a function of a data set presented to the MLA;
Learning Capacity means an Inference of the capacity of a selected User to learn a selected content;
Machine_Learning algorithm (“MLA”) means a computer implemented algorithm adapted to develop Inferences as a function of a selected set of training data;
Tag means an attribute comprising accessibility metadata, e.g., a Difficulty Metric;
User means a human who has, voluntarily, agreed to receive Content, e.g.: a student enrolled in an institute of learning; a learner who, for personal reasons, desires to receive the Content; a researcher who, for professional reasons, seeks knowledge of the Content; a teacher who, for professional reasons, desires to enhance their understanding of the Content; or an employee who, because of their job within a company, is expected to know the Content.

In FIG. 5, we have illustrated one embodiment of a Content assimilation system 38 in accordance with our invention. In this embodiment, our Server 14 is selectively connected via a Network to each of a plurality of Content providers. By way of example, we have illustrated three (3) such providers: Web servers accessible via respective Universal Resource Locators (“URLs”); publishing establishments who have agreed to make their Content accessible via the Network; and private companies who have agreed to allow our Server 14 to access and assimilate their private Content. However, we recognize that other system configurations would be possible, and, indeed, more desirable depending on the specific requirements of the system.

The following detailed description illustrates embodiments of the present disclosure and ways in which they can be implemented. Although we will disclose some modes of carrying out the present invention, those skilled in the art will recognize that other embodiments for carrying out or practicing the present disclosure are also possible.

By way of example, let us consider a particular User. From one perspective, we can train our MLA to Infer the intellectual capacity required of a User to comprehend particular Content. For the purposes of our method, we denote this as the inherent, i.e., threshold, Cognitive Skill level required of a User for effective comprehension. Clearly, it would not be especially effective to deliver to this particular User Content that is above her Cognitive Skill level. From another perspective, we can train our MLA to Infer the intellectual capability of this User: below average; average; or above average. For the purposes of our method, we denote this as the inherent, i.e., threshold, Learning Capability of this User. Again, it would not be desirable to present to this particular User Content that is above her Learning Capacity. This then is one important goal of our method: to deliver to each User only Content that satisfies at least a selected one of these threshold conditions. Accordingly, in one mode of operation, our method will select only that Content that does not require greater Cognitive Skill than this User possesses. In one other mode of operation, our method will select only that Content that is within the Learning Capability of this User.

In general, our disclosed embodiments provides a method for autonomously assimilating Content comprising one or more Assertions, using an MLA implemented in a data processing facility comprising:
a data processor facility configured to instantiate the MLA; and
a persistent memory facility configured to store the Content in a computer-readably format.

In particular, our method comprises configuring this data processing facility to perform the steps of:
adapting the MLA to Infer from each Assertion a Difficulty Metric; and
in the memory facility, associating the Difficulty Metric with the respective Assertion.

By way of example, let us consider a first Assertion, A₁: “Barak Obama was born in Nairobi”, which can be represented in triple form as follows:
(Barak_Obama, Born_In,
Nairobi) wherein:
   S=>
   “Barak_Obama”;p=
   >“Born_In”; and o
   =>“Nairobi”.

Before a User will be able to understand this Assertion, that User must first possessthe intellectual capacity to understand at least the following predicates:
1. That “Barak Obama” was a person;
2. That all persons were, at some time and place, “born”; and
3. That “Nairobi” is a real (as opposed to fictional) place.
   Note: for the purpose of this example, and of all further examples, below, we will assumethat all Assertions will have been presented to the User after having been processed using an appropriate Natural Language Processing (“NLP”) facility so that the User is fully capable of understanding the presentation form itself—only the substance is in question.

Let us now assume that our User is a child only three (3) years of age. In this case, it is doubtful that this User will have the intellectual capacity to understand any of these predicates. Depending on the culture within which this User is being reared, the age will vary at which understanding of all of these predicates can be assumed. It is, therefore, important that we train our MLA in such a way that its Inferences with respect to Cognitive Skill will be relatively imprecise or “fuzzy”, i.e., will be scaled or normalized as a function of the expected age distribution at which Users will attain the requisite Cognitive Skill level. With respect to each User, we expect that the MLA will be able to improve the Inference as a result of active feedback indicative of the reaction of the User to presentation of the Assertion. We are aware of several such feedback facilities, both biometric and query-response based, that appear to us to be appropriate for performing this function.

In general, a human teacher who is privileged to engage with a human student in a face-to-face setting has a very significant advantage over any artificial facility. The reason is that humans begin to learn body language while still in the womb. By the time an “average” human reaches adulthood, he is more than capable of detecting and, more importantly, understanding even tiny changes in the demeanor of another human. So, after working only a few minutes with a new student, our theoretical teacher will often have already “received” sufficient “information” from observing the student's responses to his presentation to be able to adapt the manner of that presentation in ways that, based on his prior experience, will tend to improve the student's reception. One significant problem that an artificial facility must overcome is to learn sufficient human body language so as to be able to make decisions based only on electronically “perceived” demeanor. Although this challenge is indeed daunting, we believe that this problem will eventually be solved, perhaps not entirely, but sufficiently well to enable artificial teachers effectively to teach humans. We recognize, however, that there are some who believe otherwise. See, e.g., Narayanan, Arvind, “How to recognize AI snake oil”, Center for Information Technology Policy, Princeton University, https://www.cs.princeton.eduharvindn/talks/MIT-STS-AI-snakeoil.pdf

Let us now assume that our User is a young adult already twenty-one (21) years of age. Unfortunately, despite not having the same chronological problem as the child in our first example, this particular User is generally considered to be intellectually disabled (no disrespect intended). In this case, it is more likely than not that our MLA would have developed a Cognitive Skill Metric that is wholly inappropriate for this User. It is to cope with such cases that we also train our MLA to develop a Difficulty Metric as a function of the Learning Capacity of our anticipated Users. Clearly, the ability of each User to understand all of these predicates will vary greatly, depending on the mental faculties of that User. It is, therefore, important that we train our MLA in such a way that its Inferences with respect to Learning Capacity will also be relatively “fuzzy”, i.e., will be scaled as a function of the expected “intelligence” distribution at which Users will attain the requisite Learning Capacity level. With respect to each User, we expect that the MLA will be able to improve the Inference as a result of active feedback indicative of the reaction of the User to presentation of the Assertion.

Please note that, in each of the above examples, it was not necessary for our system to solicit, ab initio, any “personal information” from any User. Of course, for the training to be effective, the training set upon which we train our MLA must be carefully selected so as to fairly represent the distribution of expected Users with respect to both learning capacity and level of cognitive skills. Various prior art approaches exist for selecting such a training set.

Let us now consider another, more difficult, Assertion, A₂: “Human blood is slightly basic”, which can be represented in triple form as follows:
(Blood, Is,
Basic) wherein:
   s=>“Blood”, with an
   Attribute[“Human”];p=>“Is”; and
   o=>“Basic”, with an Attribute[“Slightly”].

Before a User will be able to understand Assertion A₂, that User must first possessthe intellectual capacity to understand at least the following predicates:
1. That “Blood” is a substance that can be quantified using a measurable scale that includes the qualitative description of ‘Basic’; and
2. That “Basic” is a qualitative measure/description of the pH scale.
   In view of the more difficult nature of this Assertion and these predicates, we expect our MLA to Infer significantly higher Difficulty Metrics for both Cognitive Skill and Learning Capability. We can thus expect the Difficulty Metrics in our graph database for each of the Assertions comprising our Content to be tagged with appropriate values. Over time, as our MLA works with each User, the initial Inferred values may be automatically refined, on a per-User basis, to better fit the actual abilities of each specific User. This feedback cycle can enable the MLA to scale the Cognitive Skill of the User as a function of biometric and/or query-response based quantifications in addition to the age-dependent metric.

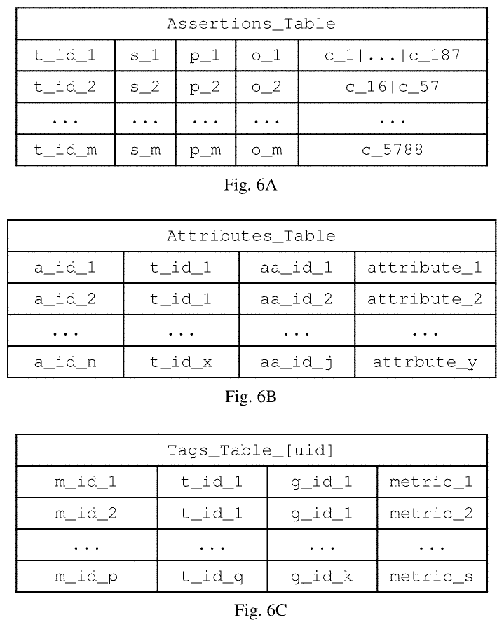

In FIG. 6, we have illustrated one embodiment of a graph database configured to instantiate the graph representation of FIG. 4. In FIG. 6A, we have depicted an Assertions_Table comprising of a plurality of rows, each comprising: a first column for storing a unique index, t_id_[1::m], assigned, usually sequential, by our system to each Assertion; a second column for storing the s element, s_[1::m], of that Assertion; a third column for storing the p element, p_[1::m], of that Assertion; and a fourth column for storing the o element, o_[1::m], of that Assertion. In FIG. 6B, we have depicted an Attributes_Table comprising a plurality of rows, each comprising a first column for storing a unique index, a_id_[1::n], assigned, usually sequential, by our system to each Attribute; a second column for storing the index, t_id_[1::m], of a respective one of the Assertions stored in the Assertions_Table; a third column for storing a code, aa_id_[1::j], uniquely identifying of the agent responsible for creating the Attribute; and a fourth column for storing the respective attribute, attribute_[1::y]. In FIG. 6C, we have depicted a Tags_Table_[uid] for storing a unique index, m_id_[1::p], assigned, usually sequential, by our system to each Tag; a second column for storing the index, t_id_[1::m], of a respective one of the Assertions stored in the Assertions_Table; a third column for storing a code, g_id_[1::k], uniquely identifying of the agent responsible for creating the Metric; and a fourth column for storing the respective metric, metric_[1::s]. In one embodiment, each User is allocated a private Tags_Table_[uid], where “uid” is a code uniquely identifying one and only one User; wherein the initial Metrics are copied from a master Tags_Table (not shown), and thereafter, over time, this private set of Metrics is dynamically adjusted by the MLA to better fit the specific User.

By way of example, we have added a fifth column to the Assertions_Table illustrated in FIG. 6A. For convenience of access, we store pointers, c [ ], to the location in the database where we have stored the specific Content from which the respective Assertion has been developed. Since it is entirely possible that any specific Assertion maybe derived from different, but semantically similar, Content. we provide for the possibility of having more than one pointer associated with each Assertion. By choice, we use a pipe symbol, “|”, to concatenate the data structures, e.g., “c_1| . . . |c_187”.

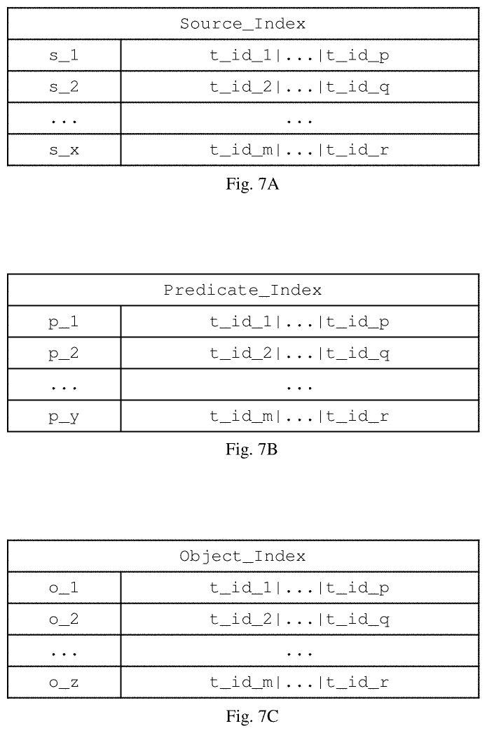

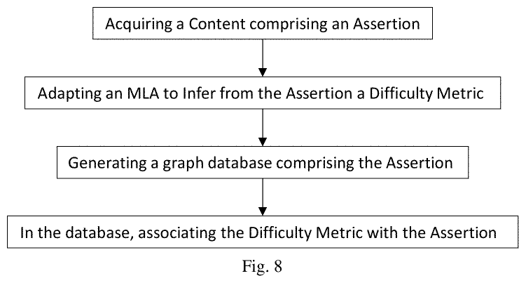

In FIG. 7, we have illustrated one embodiment of an indexing mechanism which greatly facilitates searching of the Assertions_Table by s, p or o. In this embodiment, we have instantiated three (3) index tables: a Source_Index for storing each unique s_[1::x] in the Assertions_Table in a respective row; a Predicate_Index for storing each unique p_[1::y] in the Assertions_Table in a respective row; and an Object_Index for storing each unique o_[1::z] in the Assertions_Table in a respective row. By way of example, we have depicted each index table as comprising a first column for storing each of the unique elements of the respective types; and a second column adapted to store a concatenated string of the indexes, t_id_[1::m], in the Assertions table where the respective, matching element can be found. We apply the same data formatting protocol to populate the remaining indexes, as can be seen in FIG. 7A, FIG. 7B and FIG. 7C.

In one embodiment, we can use this same mechanism to concatenate multiple, semantically similar, s∥p∥o (where “∥” represents the “logical OR” function) values for storage in a single s_[ ], p_[ ] or o_[ ] field. For example, let's add a third Assertion: “President Obama attended Harvard Business School”, which can be represented in triple form as follows:
(Obama, Attended,
Harvard) wherein:
   s=>“Obama”, with an
   Attribute[“President”];p=>“Attended”;
   and
   o=>“Harvard”, with an Attribute[“Business_School”].

Note that our first Assertion (see, Paraadapting the MLA to Infer from eachAssertion a Difficulty Metric; and
in the memory facility, associating the Difficulty Metric with the respective Assertion.

shares the same subject but using different, but semantically similar, words/phrases. Using our concatenation mechanism, our MLA can, upon detecting the semantic similarity, construct a single entry in the Source_Index table to store the indices of both the first and third Assertion, wherein the value stored in the first column (or field) looks something like this:
“s_1|s_3”; or
“Barak Obama|Obama”, using the actual source elements.
   Of course, the MLA must be trained so as not to combine Assertions relating to one person, e.g., “Barak Obama”, with those relating to a totally different person who just happens to share a name element in common, e.g., “Michelle Obama”. In the instant case, however, the Attribute “President” is sufficient to distinguish, semantically, “Barak”, once a “President”, from “Michelle”, his wife. When the MLA is not certain that the s∥p∥o values of particular Assertions are sufficiently related, the MLA should allocate different entries in the respective index table.

So, why do we believe it important to pre-assess the relative difficulty of particular content? Because curiosity is fragile and easily bruised. Imagine that the child in our first example (see, Para [0033], above) is six (6) years of age, and now able to pose the following query to our system (perhaps with some help from her older brother): “Is broccoli good for me?” How do you think this child would react if our MLA were to deliver, in response to this very simple question, something like this:
“Broccoli is a great source of vitamins K and C, a good source of folate (folic acid) and also provides potassium, fiber Vitamin C is a powerful antioxidant
and protects the body from damaging free radicals. Fiber—diets high in fiberpromote digestive health.”
   Note: this was the answer that was received in response to this exact question from www.google.com on 21 Apr. 2020.)
   We predict that the child's reaction would be decidedly negative. Clearly this content would be far more suitable for the young adult in our second example (see, Para [0035], above). However, does not the question itself, as well as its semantics, suggest that the user is a young person? We believe that current state-of-the art MLAs are quite capable of making this inference. What is needed is a mechanism to filter available content as a function of this inference. Using our invention, the MLA might select a far more suitable answer such as: “Yes, broccoli is good for you.”

Having answered our young user's query as appropriately as it could under the circumstances (and decidedly better than did Google's search engine), our MLA can now, again, take advantage of our disclosed embodiments by enriching its answer. Let us assume, for this example, that our MLA, using known methods, determines that the IP address of this user is allocated to a service provider located in Canada, a place where lots of broccoli is grown but where tropical fruits are relatively rare. So, leveraging this collateral information, our MLA searches the Content database seeking Assertions of comparable semantic content and that have associated therewith comparable Difficulty Metrics. It then enriches the answer with the following: “ . . . but Kiwi fruits are also good for you.” The child has received a basic answer it is likely to understand, but, not being familiar with something strangely exotic called “Kiwi fruits”, is now tempted by the supplemented response to pose follow-on queries.

In a general sense, we believe that a User will tend to respond positively when new knowledge is presented in a form that is only moderately challenging, but will tend to respond negatively if that same fundamental knowledge is presented in a form that is perceived as threatening, overwhelming or daunting. We submit that the problem is not the knowledge per se, but rather the form in which that knowledge is presented. This requires our system to maintain (or dynamically construct) Content comprising semantically redundant forms of the same base knowledge. As we have described above, our Difficulty Metric acts as a filter such that the MLA tends to select between semantically equivalent forms of Content in a way that is more likely than currently known approaches to present a User with knowledge in a form more appropriate for her learning ability. Presented with relevant Content in a non-threatening form, our User is more likely than not to internalize at least some of the Content. When this happens, we will have accomplished our most fundamental goal of imparting new knowledge to another human.

Embodiments of the present disclosure may reduce, and in some instances eliminate, the limitations in autonomous assimilation of a Content by pre-assessing the level of understanding required of the User.

Modifications to embodiments of the present disclosure described in the foregoing are possible without departing from the scope of the present disclosure as defined by the accompanying claims. Expressions, such as “including”, “comprising”, “incorporating”, “have” and “is”, which we have used to describe and claim the present disclosure are intended to be construed in a non-exclusive manner, namely allowing for items, components or elements not explicitly described also to be present. Reference to the singular is also to be construed to relate to the plural. Reference to the one gender is intended also to comprehend the other gender.

Although we have described our disclosed embodiments in the context of particular embodiments, one of ordinary skill in this art will readily realize that many modifications may be made in such embodiments to adapt them to specific implementations. Thus it is apparent that we have provided a method and apparatus for autonomous assimilation of Content, that, during the assimilation process, Infers Difficulty Metrics to that Content. Further, we submit that our method and apparatus provide performance generally superior to the best prior art techniques.

What we claim is:

1. A method for autonomously assimilating Content comprising an Assertion, using a Machine Learning Algorithm (“MLA”), characterized in that the method comprises configuring an electronic data processing facility to perform the steps of:
1.1 adapting the MLA to Infer from the Assertion a Difficulty Metric; and
1.2 associating the Difficulty Metric with the Assertion.

2. The method of claim 1 wherein step 1.2 is further characterized as comprising the steps of:
2.1.1 generating a database comprising the Assertion; and
2.1.2 in the database, associating the Difficulty Metric with the Assertion.

3. The method of claim 1 wherein the Difficulty Metric is further characterized as comprising a selected one of a Cognitive Skill and a Learning Capacity.

4. The method of claim 1 further characterized as comprising the steps of:
1.3 receiving from a User a Query;
1.4 selecting Content as a function of a selected Difficulty Metric; and
1.5 presenting to the User the selected Content.

5. The method of claim 3 wherein step 1.4 is further characterized as comprising the step of:
1.4 selecting Content as a function of a selected Difficulty Metric and the semantics of the Query.

6. An electronic data processor facility configured to perform the method of claim 1.

7. An electronic data processing facility comprising an electronic digital processor facility according to claim 6.

8. A non-transitory computer readable medium including executable instructions which, when executed in an electronic data processing system, causes the electronic data processing system to perform the steps of a method according to claim 1.
